(19) United States
(12) Patent Application Publication
(10) Pub. No.: US 2006/0053566 A1
(43) Pub. Date: Mar. 16, 2006

(54) Composition for pretreating fiber materials

(76) Inventors: Biancamaria Prozzo, Basel (CH); Peter Seifert, Biberbach (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 11/172,063

(22) Filed: Jun. 29, 2005

Related U.S. Application Data
(63) Continuation-in-part of application No. 10/258,688, filed on Oct. 25, 2002, now abandoned.

(30) Foreign Application Priority Data
Apr. 29, 2000 (EP) 00109303.8

(51) Int. Cl. C11D 3/00

(52) U.S. Cl. 8/115.51

(57) ABSTRACT

Compositions that include a mixture of three different ethoxylated alcohols with or without further products are useful for pretreating textile materials, especially cotton fabrics. The compositions have acceptable viscosities and are preferably used in the form of aqueous solutions or dispersions. These have little if any tendency to form foam, are highly compatible with enzymes and impart very good rewettability to textiles treated therewith.

This application is a continuation-in-part of application Ser. No. 10/258,688, filed Oct. 25, 2002, now abandoned, which is a 371 of PCT/EP/01/04762, filed Apr. 27, 2001.

This invention relates to the use of compositions that include at least three different ethoxylated alcohols for pretreating fiber materials.

Fiber materials in the form of textile fabrics, for example wovens or knits, especially cotton fabrics, normally have to be subjected to a pretreatment before they are dyed. One purpose of the pretreatment is to ensure trouble-free uniform dyeing. Depending on the prior history and provenience of the textile fabrics or the equipment available, the pretreatment may include the measures of desizing, degreasing/scouring and bleaching the textiles. These measures may be carried out separately, but in the individual case it is also possible to integrate a plurality of these measures in a single process to save costs.

To meet the requirements of a useful pretreatment process, various chemical products are used in the pretreatment. These may include, depending on the stated object, wetting agents, laundry detergents, enzymes, bleaching agents, stabilizers, complexing agents, etc. Particular importance attaches here to surfactants which are effective to provide good wettability for the textile fabrics and also good washing and cleaning effects. But the products responsible for good wettability should ideally bring about no or only an insignificant increase in the foaming tendency of baths that contain the pretreatment products. This is very important not only when the pretreatment is carried out as a batch process, for example in jet machines, but also in continuous processes. The reason why low-foaming properties are frequently demanded of pretreatment products is that it is in many cases undesirable to suppress increased foaming by adding antifoams such as silicones.

Since classic pretreatment steps such as desizing, degreasing/scouring and bleaching are in a number of cases integrated into a combined pretreatment process, there is also a demand for compositions which can be used for such combined pretreatment processes. The compositions are normally aqueous systems that impart good wettability to the textile material at the start of the pretreatment, but also good hydrophilicity at the end of the pretreatment. This good hydrophilicity leads to the good rewettability needed for the dyeing process.

Products that are useful for pretreating fiber materials in the form of textile fabrics and that include ethoxylated alcohols or end-capped derivatives thereof as surfactants are known, for example from EP-A 274 350, EP-A 360 736, EP-A 462 059, EP-A 114 788. Compositions that include mixtures of alkoxylated alcohols or derivatives thereof have also been described, for example in EP-A 696 661 and WO 92/15664.

The compositions described in the above-cited documents, although in principle suitable for textile pretreatment, do not have optimum properties in every regard. More particularly, the tendency to form foam, the excessive viscosity, the compatibility with enzymes and a strongly acidic pH present problems in a number of cases of known compositions for the pretreatment of textiles. The tendency to form foam becomes noticeable in both continuous and batch pretreatment processes, for example in the course of a batchwise pretreatment in jet machines. True, the foam can be controlled by means of silicones, but this is frequently undesirable.

It is an object of the present invention to develop a composition which has excellent utility for the pretreatment of fiber materials, especially cotton fabrics, in that it imparts good rewettability to the textile material, is highly compatible with enzymes, has an acceptable viscosity for convenient handling and does not produce unacceptable foaming even without the use of high-performance antifoams such as silicones.

This object is achieved by the use of a composition that includes the following components A), B) and C):

A) an ethoxylated alcohol of the general formula (I)

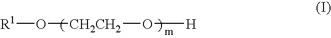

B) an ethoxylated alcohol of the general formula (II)

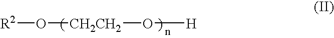

C) an ethoxylated alcohol of the general formula (III)

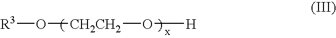

where R¹ is a linear or branched alkyl radical of 6 to 14 carbon atoms, R² and R³ are each a linear or branched alkyl radical of 10 to 18 carbon atoms,

m is from 3 to 12, preferably from 4 to 10,

n is from 3 to 18,

x is from 5 to 20,

R² and R³ each contain at least 2 carbon atoms more than R¹ and x−n is not less than 2, for pretreating fiber materials, said pretreating being performed prior to manufacture of enduse articles from said materials.

Compositions used according to the invention are preferably in the form of aqueous solutions or dispersions, i.e. include water as component D). It can be of advantage in this case for the compositions to further include as component E) an aliphatic diol of 2 to 10 carbon atoms, preferably a diol having a branched hydrocarbon chain of 4 to 8 carbon atoms in which the two OH groups are not attached to adjacent carbon atoms.

The compositions used according to the invention are very useful for the pretreatment of fiber materials, especially textile fabrics such as wovens or knits. They are particularly useful for pretreating fiber materials that are 50 to 100% by weight cellulose, especially cotton.

It is possible to provide compositions used according to the invention without the inclusion of water, in a form which does not have excessive viscosity and therefore is efficiently handleable.

Compositions used according to the invention in the form of aqueous dispersions or solutions have a pH in the range from 3 to 5 even when they include ingredients in addition to the three ethoxylated alcohols mentioned above. This makes them superior to known products having a more strongly acidic pH, since there is a risk of enzyme incompatibility at strongly acidic pH. The inventive pretreatment of textile fabrics confers excellent post-treatment rewettability on the fabrics. This has a positive effect on a subsequent dyeing process.

Compositions used according to the invention can be used for pretreatment without addition of phosphorus compounds. This is an advantage with regard to the environment, especially with regard to wastewaters.

Compositions used according to the invention in the form of aqueous solutions have little if any tendency to form unwanted foam, so that the pretreatment process is not upset by foaming. Finally, compositions used according to the invention are highly compatible with enzymes, provided no further components are included that have poor compatibility with enzymes. This good enzyme compatibility is an advantage when the pretreatment operation is to be carried out in the presence of enzymes, for example a-amylase, that cause the enzymatic degradation of size products.

Compositions used according to the invention provide rapid and easy wetting of textiles, especially cotton articles. Accordingly, the pretreatment process will work efficiently right from the beginning.

Compositions used according to the invention must include at least the components A), B) and C) mentioned above. All three components are commercially available. They are preparable by reacting the corresponding alcohols with ethylene oxide according to generally known methods.

Component A) is an ethoxylated alcohol of the general formula (I)

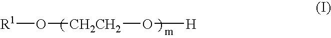

Here R¹ is a linear or branched alkyl radical of 6 to 14 carbon atoms. Preferably R¹ is a branched alkyl radical of 8 to 12, especially 9 to 11, carbon atoms. The value of m, which indicates the degree of ethoxylation, is in the range from 3 to 12, preferably from 4 to 10.

Component B) is an ethoxylated alcohol of the general formula (II)

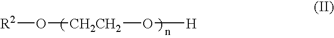

Here R² is a linear or branched alkyl radical of 10 to 18 carbon atoms, preferably a branched alkyl radical of 10 to 16 carbon atoms. The degree of ethoxylation n is in the range from 3 to 18, preferably from 4 to 10.

Component C) is an ethoxylated alcohol of the general formula (III)

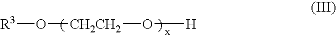

Here R³ is a linear or branched alkyl radical of 10 to 18 carbon atoms, preferably a branched alkyl radical of 10 to 16 carbon atoms. The degree of ethoxylation x is from 5 to 20, preferably from 6 to 16.

Instead of chemically pure products, each of the three components A), B) and C) may be a mixture of ethoxylated alcohols. Accordingly, each of these three components may be prepared using technical grade or naturally occurring alcohol mixtures whose individual molecules differ in the chain length of the radical R¹ or R² or R³. The ethoxylation of these alcohols leads to mixtures whose constituents differ not only in the chain length of R¹ or R² or R³ but also in the degree of ethoxylation, i.e. in the values of m or n or x. But what is important is that in a mixture of ethoxylated alcohols that is to be used as component A) the majority of the molecules, i.e. not less than 80% of all the molecules, have an alkyl chain which contains 6 to 14 carbon atoms and a degree of ethoxylation of 3 to 12. Similarly, both in component B) and in component C) not less than 80% of all the molecules, have alkyl groups having 10 to 18 carbon atoms and a degree of ethoxylation of 3 to 18 (component B)) or of 5 to 20 (component C)).

It is further important and absolutely indispensable if the advantages of compositions used according to the invention are to be obtained that not only R² but also R³ contain at least 2 carbon atoms more than R¹. In addition, the degree of ethoxylation x of component C) shall be larger by not less than 2 than the degree of ethoxylation n of component B), i.e. x−n shall not be less than 2.

The two aforementioned conditions with regard to the differences in the number of carbons in the alkyl radicals and in the degree of ethoxylation must both be met. It has been experimentally determined that the use of a mixture of three ethoxylated alcohols which on average all three have the same number of carbon atoms in the alkyl radical or on average all three have the same degree of ethoxylation is inferior to the use of compositions according to the invention with regard to the effects obtainable by pretreatment of textiles. Since normally each of the three components A), B) and C) will be a mixture of ethoxylated alcohols, it will be the case that the R² and R³ radicals occurring in the individual molecules will not all have at least 2 carbon atoms more than all the R¹ radicals present. But this abovementioned condition must be met for the average number of carbon atoms in the respective radicals R¹, R² and R³. Similarly, not every individual molecule of component C) need have a degree of ethoxylation that is not less than 2 higher than any molecule of component B). But the average degree of ethoxylation of C) must be not less than 2 higher than that of B).

When, accordingly, component A) in a certain composition used according to the invention is to be a mixture of ethoxylated alcohols which on average has an alkyl radical (R¹) of 12 carbon atoms, for example, then the average length of the alkyl radicals (R² and R³) in the components B) and C) must be not less than 14 carbon atoms in each case. Similarly, the average degree of ethoxylation x of component C) must be not less than 16 when the component B) used has an average degree of ethoxylation of 14.

All three components A), B) and C) contain no propoxylated units —CH(CH₃)—CH₂—O— and have an alkyl group at one end of the chain and an OH group at the other. This distinguishes them from a number of products which are known in the prior art for the pretreatment of textiles.

Compositions used according to the invention preferably include the components A), B) and C) in the following amounts relative to each other:

10 to 40 parts by weight of A)

3 to 30 parts by weight of B)

0.1 to 10 parts by weight of C).

In a preferred embodiment, compositions used according to the invention, as well as the components A), B) and C), further include one or more of the following components D), E), F), G) and H):

D) water

E) an aliphatic diol of 2 to 10 carbon atoms,

F) one or more aliphatic mono- or polybasic carboxylic acids of 3 to 8 carbon atoms or alkali metal salts thereof

G) hydrolyzed poly(maleic anhydride)

H) an alkylpolyglycoside.

Component E) was described above.

Component G) is a hydrolyzed polymaleic anhydride. It may be a product in which all the anhydride groups of a polymaleic anhydride have been hydrolyzed to acid groups, i.e. poly(maleic acid). But component G) may also be a partial hydrolysate in which only some of the anhydride groups have been hydrolyzed. Component G) may also be a copolymer containing hydrolyzed maleic anhydride groups. For instance, a copolymer of maleic anhydride and some other monomer, which may also contain aromatic units, may be used as component G) following partial or complete hydrolysis. The molecular weight of polymers useful as component G) is preferably in the range from 400 to 1 000. Component G), like component F) described hereinbelow, may serve as complexing agent for metal ions. Products useful as component G) are commercially available, for example “BELCLENE 200” from Great Lakes, GB, an aqueous solution of poly(maleic acid).

Component F) is an aliphatic mono- or polybasic carboxylic acid of 3 to 8 carbon atoms or an alkali metal salt thereof, especially a sodium or potassium salt. Instead of a single compound, component F) may also be a mixture of such compounds, for example a mixture of an acid and an alkali metal salt of another acid. Component F), like component G), may serve as complexing agent for metal ions in the realm of the pretreatment of textiles. Particularly useful as component G) are citric acid or gluconic acid or alkali metal salts of these acids or a mixture of such compounds.

Component H) is an alkylpolyglycoside. It may help to make compositions used according to the invention more stable to the action of alkaline substances. Alkylpolyglycosides are known, commercially available products, which are preparable by acid-catalyzed reaction of the corresponding sugars with alcohols. An example of a useful component H) is Glucopon 600 CS UP from Cognis, Germany, an aqueous solution of an oligomeric alkylglucopyranoside.

In a preferred embodiment of compositions used according to the invention, the composition includes the components A) to H) in the following relative amounts:

10 to 40 parts by weight of A)

3 to 30 parts by weight of B)

0.1 to 10 parts by weight of C)

0 to 100 parts by weight of D)

0 to 20 parts by weight of E)

0 to 20 parts by weight of F)

0 to 10 parts by weight of G)

0 to 15 parts by weight of H).

Compositions used according to the invention are normally preparable without problems by mixing the components A) to C) and any further desired components in any order by stirring at room temperature. In individual cases, a certain order of mixing and/or a temperature increase may afford benefits with regard to stability in storage. These statements also apply when compositions used according to the invention are to include further components, for example the components D) to H) more particularly described hereinabove.

If desired, compositions used according to the invention may include further ingredients, especially with regard to specific pretreatment processes and requirements. Such ingredients may be for example enzymes, complexing agents or further surfactants; they can be used in the amounts customary for pretreatment processes. However, it is advisable to precede every individual case of the use of such ingredients by an examination as to whether the stability or the abovementioned advantages of compositions used according to the invention is/are not unacceptably reduced as a result.

Compositions used according to the invention are very useful for pretreating fiber materials, especially textile fiber materials in the form of wovens or knits. The fiber materials in question may be textile fabrics comprising cellulose, regenerated cellulose or synthetic polymers or blends of such fibers. Compositions used according to the invention are particularly useful for pretreating textile fabrics which are 50 to 100 percent by weight cotton. The rest of the fibers may be synthetics, for example. Compositions used according to the invention are very useful for continuous processes, but also for batch pretreatment processes, for example in jet machines.

Compositions used according to the invention may be applied to the textile material according to methods customary in pretreatment processes, for example by dipping, pad-mangling, etc. The aqueous liquors used for pretreatment advantageously have customary concentrations, for example from 0.03 to 2 percent by weight of the sum total of the components A), B) and C), based on total liquor.

After the pretreatment, the textile material is further treated in a conventional, known manner, for example by dyeing with or without intermediate drying.

The invention will now be illustrated by examples.

Compositions were prepared in accordance with Table I below, in which the numbers under the respective examples each denote the fraction of the constituent in question, in % by weight.

Composition a) is a noninventive, comparative example. Compositions, b), c) and d) each include surfactant 1, surfactant 2 and surfactant 3 and are therefore inventive examples.

TABLE I

| | | | | | | Citric acid + | | | | Phos- | |
|---|---|---|---|---|---|---|---|---|---|---|---|
| Compo- | Surfac- | Surfac- | Surfac- | Surfac- | Surfac- | D-gluconic | Aliphatic | Alkylpoly- | Polymeric | phonic | |
| sition | tant 1 | tant 2 | tant 3 | tant 4 | tant 5 | acid | diol | glycoside | acid | acid | Water |
| a) | — | — | 2.9 | 37.2 | 1.8 | 6 + | 6 | — | 4.8 | 4.5 | 33.8 |
| | | | | | | 3 | | | | | |
| b) | 27 | 12 | 2 | — | — | 5 + | 8 | 5 | 1.5 | — | 36.5 |
| | | | | | | 3 | | | | | |
| c) | 22 | 17 | 2 | — | — | 5 + | 8 | 5 | 1.5 | — | 36.5 |
| | | | | | | 3 | | | | | |
| d) | 22 | 17 | 2 | — | — | — | 8 | 5 | — | — | 46 |

Composition a) is a commercially available pretreatment product which also includes 3 surfactants, which are all each an ethoxylated isotridecyl alcohol, i.e. do not correspond to the components A), B) and C) of the compositions used according to the invention. Composition a) has to include an organic phosphonic acid to be suitable for the pretreatment of textiles and is therefore strongly acidic.

Surfactant 1 is a branched aliphatic alcohol having on average 11 carbon atoms and an average degree of ethoxylation of 5.

Surfactants 2 to 5 are ethoxylated isotridecyl alcohols having the following average degrees of ethoxylation:

Surfactant 2: 5

Surfactant 3: 9

Surfactant 4: 7

Surfactant 5: 10

Citric acid and D-gluconic acid were partly present in the form of their sodium salts. They constitute complexing agents for metal ions.

The aliphatic diol used was a diol having 6 carbon atoms and a branched carbon chain. The two hydroxyl groups are not attached to adjacent carbon atoms.

The polymeric acid used for compositions b), c) and d) was a hydrolyzed polymaleic anhydride (Belclene 200 from Great Lakes).

The alkylpolyglycoside used was a D-glucopyranoside having an attached alkyl radical of 10 to 16 carbon atoms (Glucopon 600 CS UP from Cognis, Germany). The compositions were prepared by simply mixing at room temperature with stirring.

Compositions a) to d) were tested for viscosity (neat), pH (neat), wettability, foaming and enzyme compatibility, and compositions a), c) and d) were additionally tested with regard to rewettability.

Viscosity:

Determined at room temperature using a Rheomat RM 180 viscometer on the basis of the shearing method.

Tendency to Form Foam:

Determined using an Ahiba-Texomat foamer using aqueous liquors each containing 3 g/l of compositions a) to d). In a second series the liquors each additionally included 10 g/l of caustic soda. In each case, 200 ml of the aqueous liquor were heated to 30° C. and then transferred into a 1 000 ml graduated cylinder. Mechanical agitation was used to create foam, and the height of the foam was read off visually on the graduated cylinder. The higher the tendency to form foam, the higher the cm of foam formed reported in Table II.

Primary Wettability:

Determined using liquors as described above under “tendency to form foam”. The time was determined (in seconds) until a swatch of woven cotton immersed into a liquor has completely descended. A lower value for this time thus denotes better/quicker wetting of the fabric by the liquor in question.

Rewettability:

This is a measure of the wettability of textile fabrics after a pretreatment process has been carried out. It is desirable in commercial practice that pretreated fabrics be efficiently and rapidly rewettable in order to ensure trouble-free dyeing.

Aqueous liquors were prepared to include in each case 0.5 g of the compositions a), c) or d) per I of water. They further included an alkaline customary bleaching formula. The abovementioned aqueous liquors were used to treat swatches of knitted cotton, which were repeatedly washed off with water and then mechanically kneaded in water, squeezed off and dried. The rewettability was then measured in seconds. To this end, strips of the swatches thus treated were partly dipped into an aqueous dye solution. The time was measured for the dye solution to rise 1 cm into that part of the fabric which had not been immersed. A lower value for the rewettability in Table II (reported in seconds) thus denotes quicker/better rewetting.

Enzyme Compatibility:

Pretreatment processes frequently utilize enzymes in the pretreatment liquor to enable size products to be removed enzymatically from the fabrics. Ideally the activity of these enzymes should not be impaired by other constituents of the pretreatment liquor. This is the case in particular in the presence of strongly acidic products.

The enzyme compatibility of compositions a) to d), i.e. a possible reduction in the enzymatic activity, was determined indirectly. The basis for the method is that in the event of a composition having poor enzyme compatibility the enzymatic effect is much reduced and size products are incompletely removed from the fabric. What the method used measured was the level of residual size on fabrics after appropriate treatment with liquors each containing 10 g/l of one of the compositions a) to d). The liquors each also contained 5 ml/l of an aqueous preparation of a-amylase.

These enzyme-containing liquors of compositions a) to d) were used to subject 100% cotton fabrics bearing a starch-based size to a room temperature treatment. Prior to the treatment of the fabrics, the liquors were aged for 8 hours in order that a possible reduction in enzymatic activity may occur. After impregnation with the liquors, the fabrics were stored at room temperature for 16 hours to allow removal of the size to take place. The fabrics were then washed with hot water and subsequently the post-treatment degree of desizing was determined using a calibrated scale. In Table II below, “poor” in the “enzyme compatibility” column indicates that an appreciable fraction of the size originally present was still present on the fabrics. “Good” denotes a minimal fraction of residual size on the fabric.

The results of the tests are reported in Table II below.

TABLE II

| | | | | | | Foam formed | | |
|---|---|---|---|---|---|---|---|---|
| | pH, | Viscosity, | Wettability (sec) | | | (cm) | | |
| | 20° C. | 20° C. (neat) | Without | With | Rewettability | Without | With | Enzyme |
| Composition | neat | mPa sec | NaOH | NaOH | (sec) | NaOH | NaOH | compatibility |
| a) | 1.6 | 680 | 5 | 6 | 15 | 93 | 50 | poor |
| b) | 3.6 | 69 | 4 | 5 | — | 56 | 30 | good |
| c) | 3.8 | 74 | 5 | 7 | 10 | 20 | 30 | good |
| d) | >11 | 43 | 5 | 7 | 12 | 20 | 30 | good |
| | *) | | | | | | | |

*) The high pH of composition d) is due to the alkylpolyglycoside, which itself has a pH between 11.5 and 12.5. Unlike with compositions b) and c), no acid was added in the preparation of d).

What is claimed is:

1. A method of pretreating fiber materials in the form of textile wovens or knits, said pretreating method being performed prior to manufacture of enduse articles from said materials, which comprises applying a composition that includes the following components A), B) and C) thereto:
A) an ethoxylated alcohol of the general formula (I) 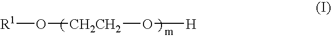
B) an ethoxylated alcohol of the general formula (II) 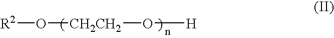
C) an ethoxylated alcohol of the general formula (III) 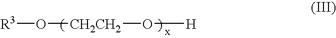
where R¹ is a linear or branched alkyl radical of 6 to 14 carbon atoms, R² and R³ are each a linear or branched alkyl radical of 10 to 18 carbon atoms,
m is from 3 to 12,
n is from 3 to 18,
x is from 5to20,
R² and R³ each contain at least 2 carbon atoms more than R¹ and x−n is not less than 2.

2. The method according to claim 1, wherein R¹ is a branched alkyl radical of 8 to 12 carbon atoms.

3. The method according to claim 1, wherein R² and R³ are each independently a branched alkyl radical of 10 to 16 carbon atoms.

4. The method according to claim 1, wherein n is from 4 to 10 and x is from 6 to 16.

5. The method according to claim 1, wherein the composition includes the components A), B) and C) in the following relative amounts:
10 to 40 parts by weight of A)
3 to 30 parts by weight of B)
0.1 to 10 parts by weight of C).

6. The method according to claim 1, wherein the composition further includes one or more of the components D), E), F), G) and H):
D) water,
E) an aliphatic diol of 2 to 10 carbon atoms,
F) one or more aliphatic mono- or polybasic carboxylic acids of 3 to 8 carbon atoms or alkali metal salts thereof,
G) hydrolyzed poly(maleic anhydride) and
H) an alkylpolyglycoside.

7. The method according to claim 6, wherein component E) is a diol having a branched saturated alkyl radical in which the two OH groups are not attached to adjacent carbon atoms.

8. The method according to claim 6, wherein component F) is present and is citric acid or an alkali metal salt thereof.

9. The method according to claim 6, wherein component F) is present and is gluconic acid or an alkali metal salt thereof.

10. The method according to claim 6, wherein the composition includes the components A) to H) in the following relative amounts:
10 to 40 parts by weight of A)
3 to 30 parts by weight of B)
0.1 to 10 parts by weight of C)
0 to 100 parts by weight of D)
0 to 20 parts by weight of E)
0 to 20 parts by weight of F)
0 to 10 parts by weight of G)
0 to 15 parts by weight of H).

11. The method according to claim 1 wherein the fiber materials are textile fabrics.

12. The method according to claim 11, wherein the fabrics are wovens or knits.

13. The method according to claim 11, wherein the fiber materials are 50 to 100% by weight cellulose.

14. The method according to claim 13, wherein the fiber materials are 50 to 100% by weight cotton.
